(19) United States
(12) Patent Application Publication
(10) Pub. No.: US 2004/0119552 A1
(43) Pub. Date: Jun. 24, 2004

(54) Electromagnetic termination with a ferrite absorber

(75) Inventor: Gordon Thomas Wray, Kitchener (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Com Dev Ltd., Cambridge (CA)

(21) Appl. No.: 10/323,895

(22) Filed: Dec. 20, 2002

(51) Int. Cl. H01P 1/26; H01P 1/23

(52) U.S. Cl. 333/22 R; 333/81 A

(57) ABSTRACT

A device for absorbing at least a portion electromagnetic energy that is provided by a transmission line and transferring the resulting heat generated by absorption to a heat sink. The device has a housing in communication with the transmission line for receiving the electromagnetic energy. The housing also provides at least a portion of an internal transmission line for confining and guiding the electromagnetic energy within the device. The housing is also in communication with the heat sink for transferring the resulting heat thereto. The device also has an absorber that is in communication with the housing for receiving the electromagnetic energy, absorbing at least a portion of the electromagnetic energy and providing resulting heat to the housing. The absorber comprises ferrite.

### FIELD OF THE INVENTION

The present invention is directed towards an electromagnetic termination. More particularly, this invention relates to absorption material with suitable absorption and heat conduction properties for use in an electromagnetic termination.

### BACKGROUND OF THE INVENTION

Radio frequency and microwave systems generally convey electrical energy from component to component using transmission lines. These transmission lines may take a variety of forms such as coaxial line, waveguide, stripline and microstrip. Many other transmission line structures are possible and well known to those skilled in the art. Useful texts on this subject include “Field Theory of Guided Waves”, IEEE Press, ©1991 by R. E. Collin; “Microwave Engineers' Handbook”, Artech House, ©1971 compiled and edited by T. S. Saad; and “Microwave Filters, Impedance Matching Networks, and Coupling Structures”, McGraw-Hill, ©1964, by G. L. Matthaei, L. Young, and E. M. T. Jones.

When designing transmission line systems, there is frequently a requirement for a component known as a termination, which ideally absorbs all of the energy propagated by a transmission line that is connected to the termination. Accordingly, the termination has an absorber for absorbing the energy. The termination is used to protect sensitive electrical components from reflected energy that could damage these components. However, in practice, a small portion of the energy may be reflected by the termination.

The electrical design of a termination involves ensuring that the reflected energy from the termination is minimal. The electrical design of the termination further requires selecting appropriate material and dimensions for the absorber to achieve a desired amount of absorption.

The thermal design of the termination involves efficiently removing heat from the termination to ensure that the total absorbed energy will not produce excessive temperatures within the termination. There are three methods for removing heat from the device: convection, radiation, and conduction. For many applications, such as a space environment, convection and radiation are ineffective leaving conduction as the only effective method of heat removal. For heat to be removed by conduction, the device must be mounted to a thermally conductive surface known hereafter as a heat sink. The heat sink may simply be the surface of a panel. Alternatively, the heat sink may be a specially designed device for removing heat such as a metallic device having fins. The thermal design of the termination now involves effectively transferring the heat from the absorber to the heat sink in order to minimize the temperature rise within the termination. A large temperature rise within the termination may cause physical damage to the materials of the termination. Furthermore, the performance of the termination deteriorates as the temperature sensitive components within the termination reach ever higher temperatures.

Ensuring reasonable temperatures within the termination can be challenging as the termination is made smaller and/or the energy that must be absorbed becomes larger. Since, the temperature rise in the absorber is a function of the thickness of the absorber, designs in which the thickness of the absorber has been increased to increase the amount of attenuation are particularly troublesome.

Accordingly, the absorption material must have suitable thermal properties in conjunction with suitable absorption or loss characteristics (i.e. a high loss tangent). For example, an absorption material with a low absorption characteristic results in a large termination which may not be suitable for certain applications, such as, but not limited to spacecraft applications, in which there are restrictions on the mass and size of spacecraft equipment.

Two termination absorption materials that are commonly used in the art include RS4200-CHP™ (i.e. silicon carbide) and loaded epoxy materials such as MF-124™. The loaded epoxy materials consist of powdered absorbers such as carbonyl iron powder or iron silicide encapsulated in an organic binder such as a rubber or an epoxy. The thermal and absorption characteristics of these materials are shown in Table 1. In Table 1, temperature stability is described in a qualitative fashion based on the temperature variation of the absorption and the impedance of a termination employing these absorption materials. Furthermore, service temperature indicates the maximum operating temperature of the material.

TABLE 1
Loss and Thermal Properties of Prior Art Absorption Materials

| | | Thermal | Temperature | Service |
|---|---|---|---|---|
| Material | Absorption* | conductivity | Stability | Temperature |
| RS4200- | 8.0 | 71.2 W/m · K | Poor | 1094° C. |
| CHP ™ | | | | |
| MF-124 ™ | 23.3 | 1.3 W/m · K | Acceptable | 180° C. |

*shown here as a dimensionless quantity since the amount of absorption depends on the geometry of the absorber and the test structure

The values in Table 1 indicate that RS4200-CHP™ has excellent thermal conductivity but poor temperature stability. Furthermore, RS4200-CHP™ has only moderate absorption properties. Consequently, a termination that employs RS4200-CHP™ as the absorption material may be unduly large for a high power application where temperatures are generally quite high.

Alternatively, MF-124™ provides good absorption, is temperature stable, and is easy to machine. Furthermore, at low power levels, the low thermal conductivity of MF-124™, and loaded epoxy absorbers in general, is not a concern. However, for terminations the current trend is moving towards high power applications. MF-124™, and loaded epoxy absorption materials in general, are unsuitable for high power applications due to poor thermal conductivity since these materials comprise RF absorbing particles that are encapsulated in a resin that does not effectively conduct the heat generated by the electromagnetic absorbing particles upon absorption of the electromagnetic energy. Accordingly, these materials get very hot in high power applications.

For high power applications, the absorption properties and thermal characteristics of the absorption material are important since more power must be absorbed by the absorption material and the higher absorbed power leads to a greater thermal flux density within the absorption material. Without the selection of a suitable absorption material, the increased thermal flux density affects the electromagnetic properties and the structural integrity of the absorption material which may cause failure of the termination.

Accordingly, there is a need for an absorption material that, in high power applications, can provide adequate absorption of electromagnetic energy (i.e. a high loss tangent) and a high thermal conductivity, to keep internal temperatures as low as possible. Furthermore, the absorption material should be able to operate at very high temperatures without physical degradation and have stable electromagnetic properties over a wide temperature range.

### SUMMARY OF THE INVENTION

In a first aspect, the invention provides a device for absorbing at least a portion of electromagnetic energy that is provided by a transmission line and transferring the resulting heat generated by absorption to a heat sink. The device has a housing in communication with the transmission line for receiving the electromagnetic energy. The housing provides at least a portion of an internal transmission line for confining and guiding the electromagnetic energy within the device. The housing is also in communication with the heat sink for transferring the resulting heat thereto. The device also has an absorber that is in communication with the housing for receiving the electromagnetic energy, absorbing at least a portion of the electromagnetic energy and providing resulting heat to the housing. The absorber comprises ferrite.

In a second aspect, the invention provides a device for absorbing at least a portion of electromagnetic energy propagated within a transmission line and for transferring resulting heat from absorption of the at least portion of electromagnetic energy to a heat sink. The transmission line has an extension that provides a housing for the device. The housing is in communication with the heat sink for transferring the resulting heat thereto. The housing also provides an internal transmission line for confining and guiding the electromagnetic energy within the device. The device additionally includes an absorber that is disposed within the housing. The absorber is in communication with the internal transmission line and the housing for receiving the electromagnetic energy, absorbing the at least portion of electromagnetic energy and transferring the resulting heat to said housing. The absorber comprises ferrite.

### BRIEF DESCRIPTION OF THE DRAWINGS

For a better understanding of the present invention and to show more clearly how it may be carried into effect, reference will now be made, by way of example only, to the accompanying drawings which show preferred embodiments of the present invention and in which:

FIG. 1a is a top view of a test termination structure with the lid removed;

FIG. 1b is a partial cross-sectional side view of the test termination structure of FIG. 1a;

FIG. 2a is a cross-sectional side view of a termination comprising a ferrite absorber in accordance with the present invention;

FIG. 2b is a cross-sectional side view of an alternative embodiment of the termination shown in FIG. 2a;

FIG. 3a is a cross-sectional side view of a termination comprising a composite absorber incorporating a ferrite and a dielectric;

FIG. 3b is a cross-sectional side view of an alternative embodiment of the composite absorber shown in FIG. 3a;

FIG. 3c is a cross-sectional side view of another alternative embodiment of the composite absorber shown in FIG. 3a;

FIG. 4a is a partial cross-sectional top view of an alternative termination in accordance with the present invention;

FIG. 4b is a partial cross-sectional side view of the termination of FIG. 4a;

FIG. 5 is a side elevational view of an example of a portion of a C Band termination;

FIG. 6a illustrates top, side and front views for a dual wedge termination;

FIG. 6b illustrates top, side and front views for a dual taper termination;

FIG. 6c illustrates top, side and front views for a channeled wedge termination;

FIG. 6d illustrates top, side and front views for a dielectric loaded wedge termination;

FIG. 6e illustrates top, side and front views for a slab termination;

FIG. 6f illustrates top, side and front views for a stepped termination;

FIG. 6g illustrates top, side and front views for a cylindrical termination;

FIG. 6h illustrates top, side and front views for a ridged waveguide termination;

FIG. 7a is an isometric view of a step taper termination for a coaxial transmission line;

FIG. 7b is an isometric view of a conical taper termination for a coaxial transmission line;

FIG. 7c is an isometric view of an inverted conical termination for a coaxial transmission line;

FIG. 8 is a cross-sectional side view of an attenuator for use with a waveguide transmission line structure;

FIG. 9a is a block diagram of a device comprising an attenuator and a termination; and,

FIG. 9b is a block diagram of a device comprising a series of attenuators.

### DETAILED DESCRIPTION OF THE INVENTION

The examples shown herein are offered by way of illustration only and not by way of limitation. Furthermore, the term absorber is used herein to refer to an embodiment of an absorption material suitable for use in a termination that is connected to a transmission line structure. In addition, like numerals in different figures represent the same object. It is also to be understood that for the devices illustrated and described herein, the housing, either alone (such as in a waveguide-type embodiment) or in cooperation with a conductor (such as in a coaxial, stripline or microstrip type embodiment), provides an internal transmission line for confining and guiding electromagnetic energy within the devices. In addition, the term junction used herein, may be considered to be an interface. Furthermore, the housing of the devices described herein may act as a heat sink for the enclosed absorber and these housings may also be attached to an external heat sink which may be any thermally conductive surface such as a panel or a physical device such as radiating fins.

It is known that ferrites are employed in tiles that are used for the suppression of electromagnetic reflections in anechoic chambers and in panels that are placed on the outside of buildings. Ferrites are also mixed into paint to reduce radar reflections from aircraft, and mixed into rubber to form seals for microwave ovens. However, in these applications, the absorption material is not required to absorb the entire incident electromagnetic energy. Therefore, characteristics such as thermal stability are less critical since the power density of the incident electromagnetic energy is much lower than that in a typical termination. In comparison with a higher power termination, a smaller amount of heat is generated within the absorption material in the aforementioned applications.

For example, a termination may be subjected to 65 W of electromagnetic power that is dissipated in an area having dimensions of 0.65 inches by 0.8 inches which results in a power density of 125 W/in². In contrast, absorption panels are used for buildings to receive electromagnetic power broadcasted by a radio station in which the broadcasted electromagnetic power may be many megawatts at the source. However, the electromagnetic power absorbed by an absorption panel may only be a few watts and spread over a surface area that is much larger than that of an absorber in a termination. Accordingly, the panels on a building are unlikely to exceed 70° C. Another example is the usage of ferrite in microwave oven door gaskets to absorb microwave energy. Microwave ovens typically have dimensions of 16 inches by 12 inches by 12 inches and power levels ranging from 150 W to 1000 W which results in a power density that is approximately 25 to 100 times smaller than that experienced in the termination example given above.

In addition, the use of ferrites as an absorption material for terminations used with a transmission line structure has heretofore not been suggested. This observation is supported by the fact that the manufacturers of absorption materials for use in terminations do not list ferrite as an absorption material. There may be a variety of reasons for this omission. For instance, the temperature stability of many ferrites is known to be poor. For example, some ferrites that are used in tiles for anechoic chambers are temperature sensitive with magnetic properties that change by 50% at temperatures of 100° C. In addition, the electromagnetic properties of ferrites can vary to a large extent in the 1 GHz to 100 GHz range. Ferrites are also brittle materials, which results in higher machining/processing costs during the machining of ferrite components.

The inventor of the present invention has found that sintered ferrites having a high thermal conductivity provide an adequate level of absorption and thermal conduction for producing a fairly compact design for terminations used in high power applications. The ferrite must be in a solid, sintered form since solid ferrites are capable of higher thermal conductivity than ferrite powders encapsulated in an epoxy. The thermal conductivity of many ferrites is in the range of 3.2 to 4 W/m·K. However, with proper preparation, the thermal conductivity of a sintered ferrite can be increased by 40 to 50 percent which results in a thermal conductivity of approximately 4.8 to 6 W/m·K. A higher thermal conductivity is beneficial since it allows for heat to be more quickly removed from within the absorber.

Sintered ferrites with a high thermal conductivity also tend to be less porous. The sintering process is a carefully controlled manufacturing process, the details of which are proprietary to the commercial suppliers of these materials. However, the sintered ferrite preferably has a low porosity since this characteristic is associated with good thermal conductivity. An additional desirable property of a sintered ferrite is that it can typically withstand more than a thousand degrees Celsius of heat and still maintain physical integrity. This high temperature limit contrasts with absorption materials that comprise ferrite particles in a resin that breaks down at around 300° C. These materials are usually rated for use at temperatures that are lower than 260° C.

The temperature stability of ferrite is somewhat related to its Curie temperature which is the temperature at which ferrite becomes non-magnetic and ceases to absorb electromagnetic energy. Accordingly, the sintered ferrite preferably has a Curie temperature that is higher than the maximum temperature that the absorber will experience, which is often in the neighborhood of 200° C. Hence, the Curie temperature for the ferrite absorption material is preferably above 300° C. The ferrite absorption material also preferably has a resistivity which is more than 10³ Ω/cm. The high resistivity allows the electromagnetic energy to penetrate deeper within the absorber and hence be absorbed by a greater portion of the ferrite absorber.

Ironically, sintered ferrites which provide good absorption (i.e. are lossy) for high power applications are generally manufactured to achieve low-loss (i.e. low absorption) in magnetically biased devices such as circulators. However, this magnetically biased environment does not usually occur in electromagnetic terminations. For example, in spacecraft applications there are restrictions on the magnetic fields produced by the spacecraft equipment to prevent interference between different pieces of equipment. Accordingly, the magnetic conditions in terminations for spacecraft applications are low.

The absorber must retain its electromagnetic characteristics over a wide temperature range. To test an absorption material for temperature stability, performance versus temperature may be measured for a representative test fixture (i.e. a structure which is somewhat similar to a termination) utilizing the absorption material under operating conditions expected in high power applications. The performance measurement involves measuring the variation of the absorption and impedance of the test device versus temperature. It is desirable for the amount of absorption to remain stable over temperature. Furthermore, impedance variation is important since the value of a termination impedance is chosen to provide a good match to the impedance of the transmission line structure to which the termination is connected in order to minimize the reflection of electromagnetic energy from the termination. Hence, it is desirable for the termination impedance to vary as little as possible with temperature so that the termination can continue to be fairly well matched to the transmission line throughout the operating temperature range.

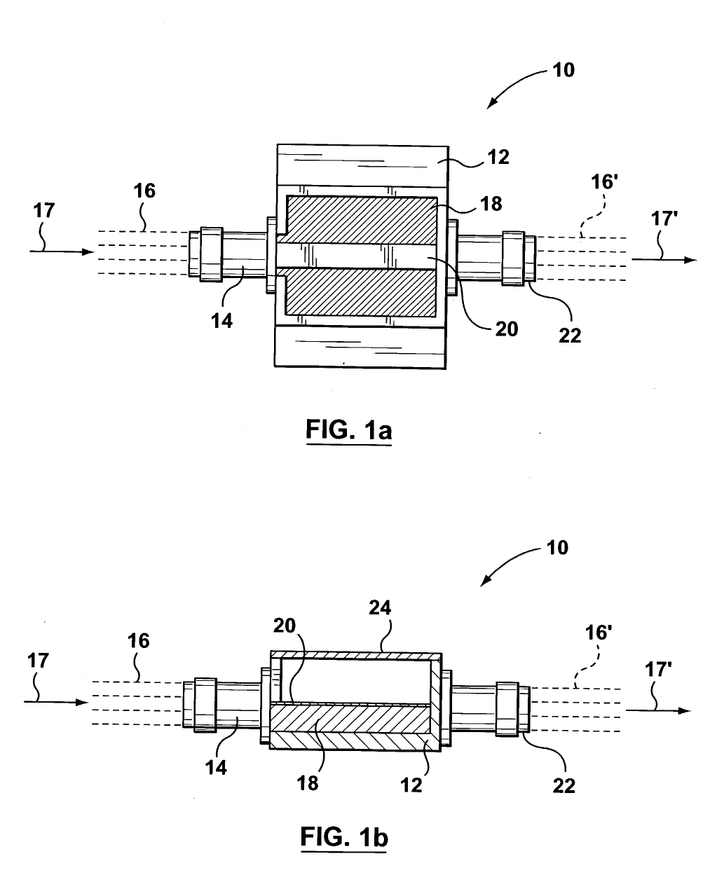

Table 2 shows the experimental results for several tested absorption materials (which include the prior art materials discussed previously). Testing involved placing an absorber between a stripline conductor and a metallic housing to simulate an actual termination as shown in FIGS. 1a and 1b. The test device 10 comprises a housing 12 and a first connector 14, a second connector 22, and a conductor 20. In this configuration, the test device 10 resembles an attenuator. The first connector 14 connects the test device 10 to a coaxial transmission line 16 in order to receive electromagnetic energy 17 and absorb at least a portion of the electromagnetic energy. The coaxial transmission line 16 is represented by dotted lines in FIGS. 1a and 1b. The second connector 22 connects the test device 10 to a downstream coaxial transmission line 16′ (also represented by dotted lines) in order to transmit the reduced or remaining electromagnetic energy 17′ therealong. The conductor 20 is connected to the center conductor of both the input connector 14 and the output connector 22. The housing 12 is made from an electrically and thermally conductive material such as aluminum. The housing 12 confines the incoming electromagnetic energy within the test device 10. The housing 12 together with the conductor 20 further provides an internal transmission line for guiding the electromagnetic energy 17 within the test device 10. The housing 12 also provides structural support for the test device 10. The connectors 14 and 22 are typically connected to the housing 12 via fasteners.

The test device 10 additionally includes an absorber 18 for absorbing the electromagnetic energy 17 that is provided by the coaxial transmission line 16. The conductor 20, in cooperation with the housing 12, guides the electromagnetic energy 17 received from the connector 14 along the absorber 18 into which the electromagnetic energy 17 penetrates. The conductor 20 is preferably bonded to the absorber 18 using a compliant adhesive such as RTV™ such that there are no air gaps therebetween since air gaps adversely affect the performance of the test device 10 and the measurement process. The test device 10 also has a lid 24 that forms part of the housing 12 and is attached via fasteners (not shown) to the test device 10 such that there is no leakage of electromagnetic energy from the test device 10. The absorber 18 was chosen to have a thickness of 0.08 inches, a length of 0.85 inches and a width of 1.0 inches (these dimensions are an example only and are not meant to limit the invention).

The test results were characterized in terms of absorption stability, match stability and temperature stability and are summarized in Table 2. Absorption stability is defined as the variation of the absorption of electromagnetic energy during an increase in temperature. Match stability is defined as the variation of the impedance of the test device during an increase in temperature. Temperature stability is a judgment of the relative merit of the absorption material based on the absorption and match stability. The test results were obtained during a temperature increase from 25° C. to 200° C. which was effected by applying heat to the bottom of the housing 12 of the test device 10.

The experimental results show that the preferred absorption material is a sintered Ni—Zn ferrite having an approximate molar composition of 0.2 moles of zinc oxide and 0.8 moles of nickel oxide for every mole of iron oxide. This composition may be represented by the formula (ZnO)_{0.2}(NiO)_{0.8}Fe₂O₃. A ferrite material TT2-4000™ manufactured by Trans-tech (a subsidiary of Alpha Industries) is an example material having approximately this composition. The precise formulation and the sintering process used to produce TT2-400™ is proprietary to the supplier. As can be seen, this ferrite material has superior thermal properties compared to MF-124™ and better absorption characteristics and temperature stability than RS4200-CHP™. Furthermore, the Ni—Zn ferrite has an absorption that increases with an increase in temperature (i.e. positive 13.7%) which is in contrast to RS4200-CHP™ which has an absorption that decreases with an increase in temperature (i.e. negative 27%). As a general guide, any Ni—Zn ferrite with a high Curie temperature (i.e. approximately 300° C. or higher), a high thermal conductivity (i.e. approximately 3.2 W/m·K or higher) and a loss tangent greater than 0.1 is preferable. However, the relative importance of these characteristics depend on the application and must be judged on a case-by-case basis.

TABLE 2
Experimental results

| | | Thermal | Absorp- | | |
|---|---|---|---|---|---|
| | Absorption | conductivity | tion | Match | Temp. |
| Material | (dB) | (W/m · K) | Stability | Stability | Stability |
| RS4200- | 8.0 | 4.4 | −27% | 37% | Poor |
| CHP ™ | | | | | |
| MF- | 23.3 | 1.3 | * | * | acceptable |
| 124 ™ | | | | | |
| Ni—Zn | 11.3 | 7.2 | +13.7% | 13.4% | good |
| Ferrite | | | | | |

* property was not measured but assumed to be acceptable

The inventor limited his investigation to nickel-based ferrites, but anticipates that lithium-based ferrites with high Curie temperatures may also be appropriate absorption materials for high power applications. This conclusion is based on the observation that lithium-based ferrites that are used in transformer coils for cell phones become quite lossy at higher frequencies. Furthermore, lithium-based ferrites also have a high dielectric constant and may be sintered to provide an appropriate thermal conductivity.

The inventor has also found that the dielectric constant of the ferrite material correlates well with the porosity of the ferrite material and hence the thermal conductivity of the ferrite material. For instance, a ferrite material with a low porosity also has a high dielectric constant which may, for example, be on the order of 12 to 14. In contrast, dielectric constants on the order of 7 to 9 are found for ferrites used in prior art applications such as anechoic chamber tiles and ferrite beads.

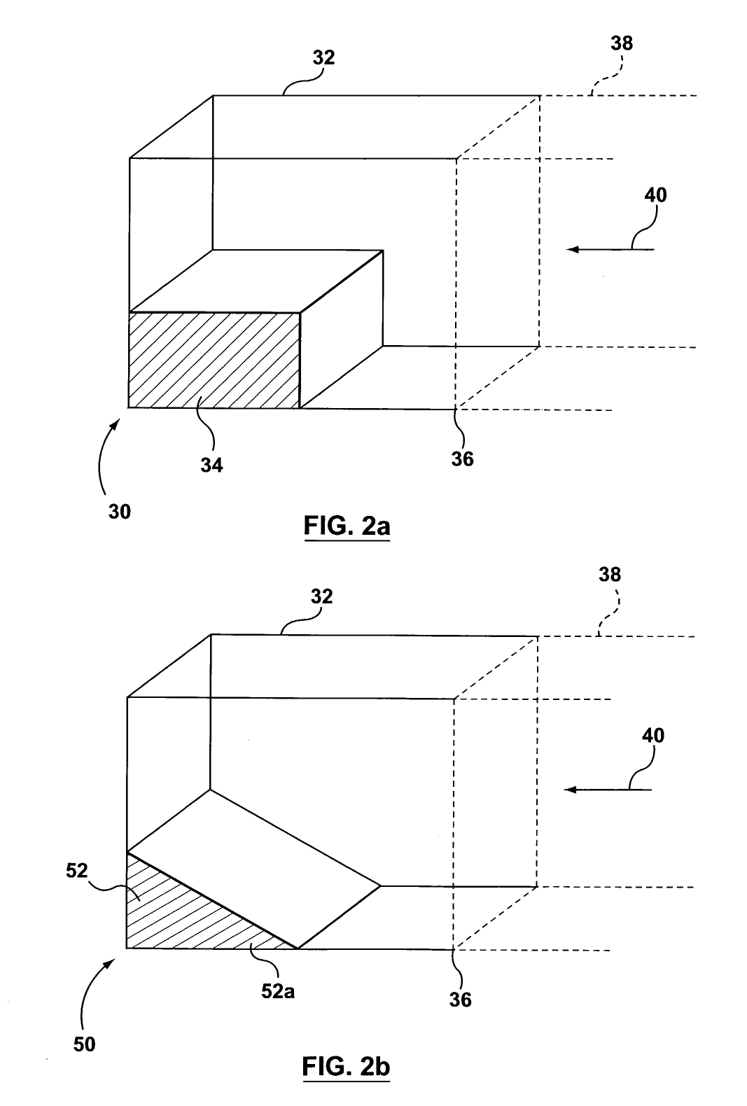

Referring now to FIG. 2a, shown therein is another example of a termination 30 comprising a housing 32, an absorber 34 disposed within the housing 32, and a junction 36 between-the termination 30 and an external transmission line structure 38 which in this example is a waveguide represented by dotted lines. The junction 36 forms an interface through which energy may pass between the external transmission line 38 and the termination 30. The housing 32 is electrically conductive and provides an internal transmission line structure which confines and guides the electromagnetic energy 40 provided by the external transmission line structure 38. The absorber 34 is made from a ferrite absorption material which is suitable for reducing and preferably absorbing all of the electromagnetic energy 40 in accordance with the present invention. The absorber 34 may be soldered to the housing 32 if the coefficient of thermal expansion of the housing 32 and the absorber 34 are similar. Alternatively, the absorber 34 may be bonded to the housing 32 using a compliant adhesive such as RTV™ (Room Temperature Vulcanization) provided by NUSIL. RTV™ has a high operating temperature and an adequate elasticity to accommodate thermal mismatches. The transmission line structure 38 provides electromagnetic energy, represented by the arrow 40, to the termination 30. The termination 30 may be for use with any transmission line structure such as, but not limited to, a waveguide, a coaxial line, a stripline, or a micro-strip transmission line. For the embodiment shown in FIG. 2a, the termination 30 is physically separate from the transmission line structure 38 and must be attached to the transmission line structure 38 at junction 36 to receive the incoming electromagnetic energy 40. The connection may be effected by soldering or laser welding. Alternatively, the termination 30 may have a flange (not shown) at the left of the junction 36 which may be attached to a flange (not shown) on the transmission line structure 38 at the right of junction 36 by bolts or the like. For the embodiment shown in FIG. 2a, the transmission line structure 38 has a waveguide structure. For alternative transmission line structures such as coaxial line, other methods of physical attachment such as coaxial connectors may be appropriate.

In another alternative, the absorber 34 may be inserted within the transmission line structure 38 and fixed in place. In this case the end portion of the transmission line structure 38 near junction 36 is extended to be in physical contact with the absorber 34 and acts as the housing 32 as well as a heat sink for the enclosed absorber 34. The transmission line structure 38 also conveys the electromagnetic energy 40 to the absorber 34. In either case (i.e. a separate termination structure or a termination structure that is integrated within the transmission line structure 38), the absorption material comprises a ferrite which has a high loss tangent (i.e. good electromagnetic absorption) and a high value of thermal conductivity as described previously.

Referring now to FIG. 2b, shown therein is an alternative embodiment of a termination 50 which is similar to the termination 30 except for the use of an alternative absorber 52. The absorber 52 is preferably made from a sintered ferrite having a high loss tangent and a high thermal conductivity as mentioned above for reducing and preferably absorbing all of the electromagnetic energy 40. However, the cross-section of the absorber 52 is varied along (i.e. parallel to) the direction of propagation of the electromagnetic energy 40. This variation in cross-section reduces the mismatch between the impedance of the termination 50 and the impedance of the transmission line structure 38 that transmits the electromagnetic energy 40 to the termination 50. The reduced mismatch is due to the upward slope of the absorber 52 which provides for a more gentle transition between the impedance of the transmission line structure 38 and the impedance of the housing 32 containing the absorber 52.

The variable cross-section of the absorber 52 also alters the absorption profile of the absorber 52. The absorption profile is defined as the amount or percentage of electromagnetic energy that is absorbed along the length of the absorber 52. The absorption profile of the absorber 52 is improved since not as much electromagnetic energy 40 is absorbed at the frontal portion 52a of the absorber 52 because of the reduced thickness thereat. Accordingly, the absorber 52 absorbs more electromagnetic energy 40 towards the rear of the absorber 52 due to the increasing thickness of the absorber 52. This is important since the electromagnetic energy is at full strength at the front 52a of the absorber 52. Absorbing a smaller portion of the full strength electromagnetic energy 20 at the front 52a of the absorber 52 produces a better distribution of heat generation within the absorber 52. Accordingly, varying the thickness of the absorber 52 in a direction parallel to the direction of propagation of the electromagnetic energy 40 alters the absorption profile of the absorber 52.

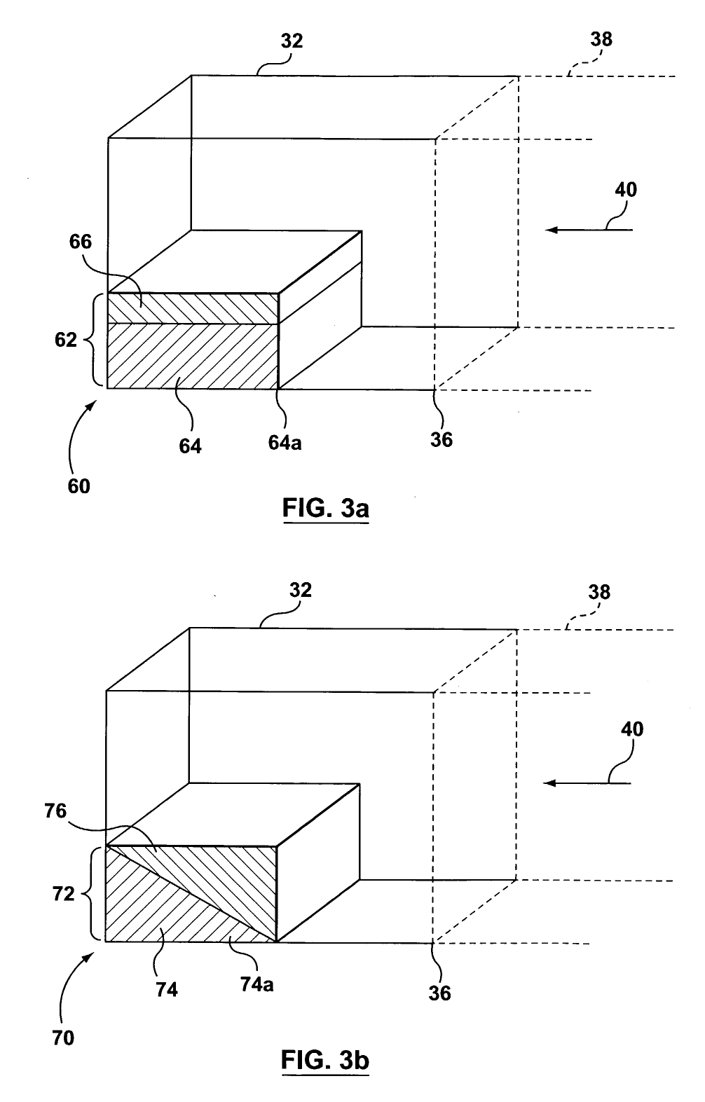

Referring now to FIG. 3a, shown therein is an alternative embodiment of a termination 60 comprising a composite absorber 62 having an absorber 64 and a dielectric 66. The dielectric 66 may be attached to the absorber 64 using an adhesive if appropriate. The absorber 64 is preferably made from a sintered ferrite having a high loss tangent and a high thermal conductivity, as mentioned above for reducing and preferably absorbing all of the electromagnetic energy 40. The dielectric 66 is any dielectric being able to withstand high temperatures such as boron nitride, teflon™, glass and glass ceramics. The composite absorber 62 allows for a reduction in absorption by providing a smaller sized absorber 64. However, the smaller sized absorber 64 may be too thin to machine alone. Accordingly, the dielectric 66 provides a support structure for the thinner absorber 64 to increase the sturdiness of the absorber 64. The composite absorber 62 can be manufactured from larger-sized materials which are combined into a composite structure and ground to a desired size. The dielectric 66 serves to support the absorber 64 during the machining operation and during the installation of the composite absorber 62 into the termination 60. Moreover, the usage of a thinner absorber 64 results in a reduced amount of absorption which is beneficial when the absorber 64 is placed in a region where the incoming electromagnetic energy 40 is at full strength. This high field region occurs at the front 64a of the absorber 64 or in the central portion of the transmission line structure 38 when viewed along the longitudinal axis of the transmission line structure 38. The reduced amount of absorption also results in a reduction in the generated heat within the absorber 64 with the effect of reducing heat concentration. However, the termination 60 must be made larger as a consequence.

The effective dielectric constant of the composite absorber 62 is between the dielectric constants of its constituent components. Accordingly, selecting a dielectric 66 with a dielectric constant that is lower than the dielectric constant of the absorber 64 results in a lower effective dielectric constant for the composite absorber 62. In general, the transmission line structure 38 contains a low dielectric constant material like teflon™, air or vacuum. Accordingly, the reduced effective dielectric constant for the composite absorber 62 is easier to match to the transmission line structure 38 than a similar sized absorber made from ferrite alone. Furthermore, the temperature variance of the electromagnetic properties of the composite absorber 62 is improved compared to a similarly sized absorber made from ferrite alone since dielectrics are well known to be more temperature stable than ferrites.

Referring now to FIGS. 3b and 3c, shown therein are two alternative embodiments of terminations 70 and 80 having composite absorbers 72 and 82. The composite absorber 72 has an absorber 74 and a dielectric 76 which both have a thickness that varies in a direction parallel to the direction of propagation of the electromagnetic energy 40. The composite absorber 82 also has an absorber 84 and a dielectric 86, the relative proportions of which varies in a direction parallel to the direction of propagation of the electromagnetic energy 40. In accordance with the previous terminations discussed above, each absorber 74 and 84 is a sintered ferrite having a high thermal conductivity and a high loss tangent for reducing and preferably absorbing all of the electromagnetic energy 40. Furthermore, each dielectric 76 and 86 is a dielectric having the ability to withstand high temperatures. In each of these embodiments, the overall dielectric constant of the composite absorber 72 and 82 may be diluted with respect to the dielectric constant of the absorber 74 and 84 respectively by selecting dielectrics 76 and 86 which have a smaller dielectric constant than the absorbers 74 and 84. More importantly, in each of these embodiments, a smaller amount of the electromagnetic energy 20 is absorbed in the frontal portion 74a and 84a of each absorber 74 and 84 since the absorber is thinner in the frontal portion 74a and 84a relative to the remainder of the absorber 74 and 84 respectively. This results in a better distribution of heat generation within the absorbers 74 and 82 as previously discussed.

In general, the terminations shown in FIGS. 3a-3c may be described as having a composite absorber comprising a sintered ferrite with a high loss tangent (i.e. high absorption) and a high thermal conductivity, and at least a partial layer of a low-loss dielectric. Furthermore, for the embodiments of the terminations described and illustrated herein, the absorber may be constructed from the aggregation of several ferrite pieces, such as slabs and/or wedges, to form a uniform body of ferrite or a body of ferrite with a dimension that varies in a direction parallel or transverse to the direction of propagation of the electromagnetic energy 40.

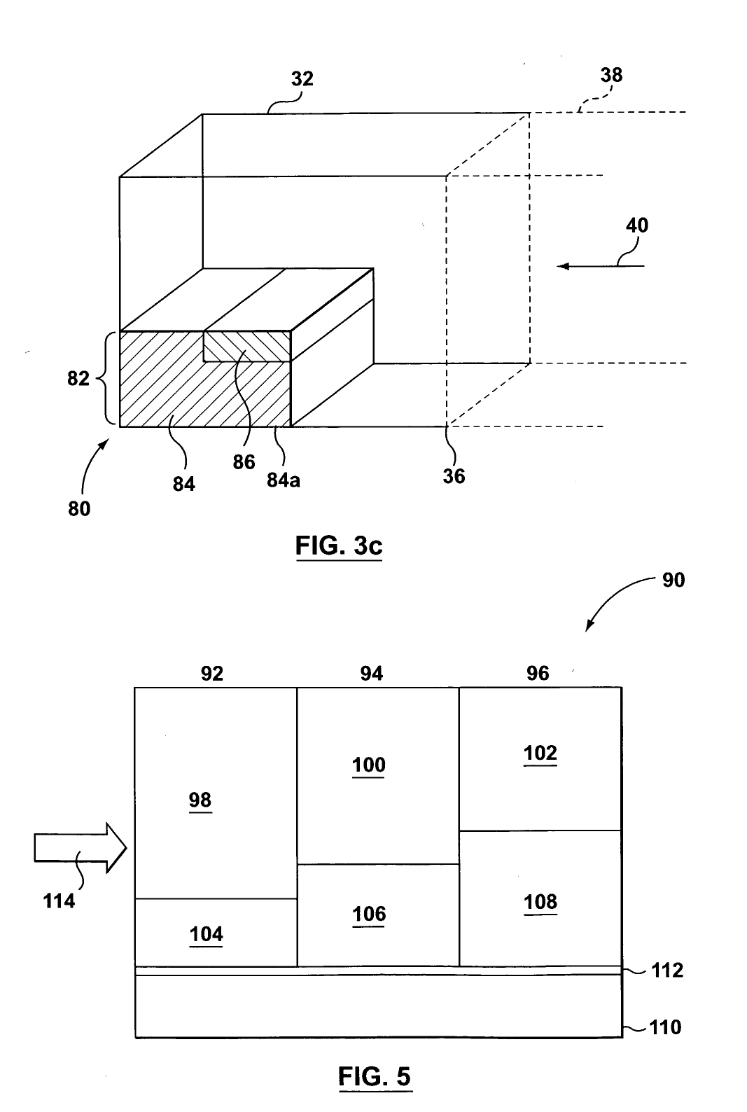

Referring now to FIGS. 4a and 4b, shown therein is another alternative embodiment of a termination 10′ in accordance with the present invention. The termination 10′ is for use with a coaxial transmission line 16. The termination 10′ has structural components that are identical to the test device 10 except for the absence of the second connector 22. The absorber 18 of the termination 10′ is adapted to absorb substantially all of the electromagnetic energy that is provided by the coaxial transmission line 16. This involves selecting an appropriate absorption material and dimensions for the absorber 18. The absorption material may be a sintered ferrite having a high loss tangent and a high thermal conductivity as previously described. Furthermore, the absorber 18 may be a composite absorber, as discussed previously, if so desired.

Example: A C band Coaxially-Fed Termination

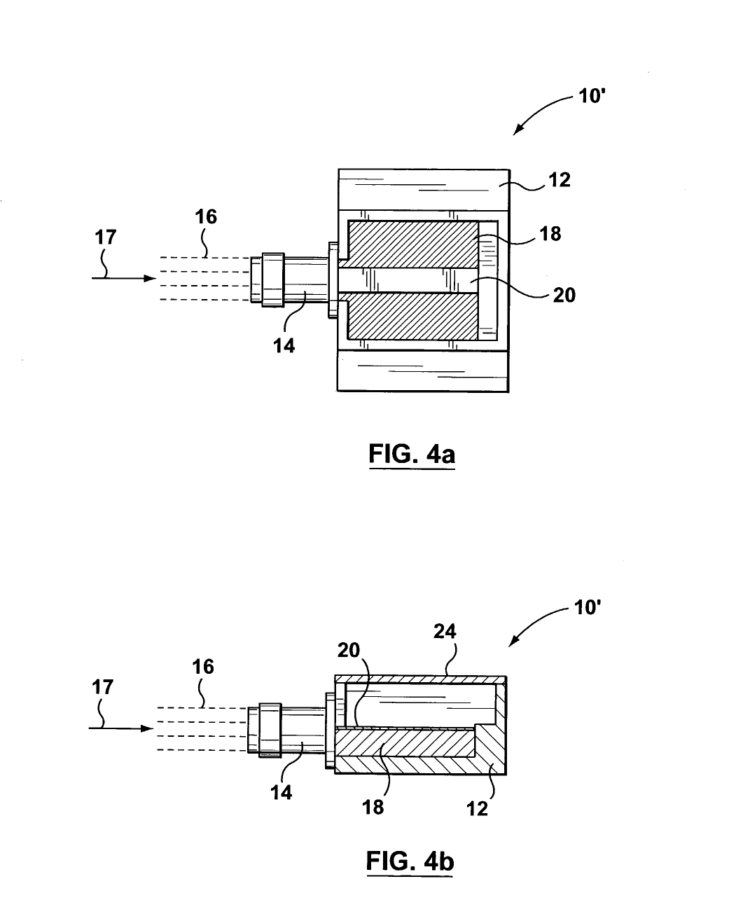

The utility of ferrite as an absorber for a termination will now be illustrated by an example which uses geometry and power levels that are encountered in high power C band terminations. Referring now to FIG. 5, shown therein is a portion of a termination 90 comprising three composite absorbers 92, 94 and 96 having respectively dielectric portions 98, 100 and 102 and absorber portions 104, 106 and 108. The termination 90 further includes a heat sink 110 and an adhesive 112 for attaching the composite absorbers 92, 94 and 96 to the heat sink 110. The adhesive 112 has a thermal conductivity sufficient to effectively conduct the generated heat from the absorber portions 104, 106 and 108. The heat sink 110 is a portion of a transmission line structure such as the wall of a waveguide or ground plane of a microstrip structure. The incoming electromagnetic energy is represented by the arrow 114.

The absorber portions 104, 106 and 108 in the termination 90 are each responsible for dissipating a fraction of the total incoming electromagnetic energy 114, although not necessarily equally. For instance, if the power of the electromagnetic energy 114 is 150 watts then 30 watts may be absorbed by the first absorber portion 104, which is one-fifth of the total power. The next absorber portion 106 can then be adjusted (i.e. made thicker) to absorb forty percent of the remaining power, which is 48 watts. Finally, the absorber portion 108 may then be made thicker to absorb one hundred percent of the remaining electromagnetic energy, which is 82 Watts. The energy absorbed by each absorber portion 104, 106 and 108 is a function of the thickness and the material characteristics of each absorber portion 104, 106 and 108 as well as the field strength of the electromagnetic energy in the vicinity of each absorber portion 104, 106 and 108.

Now considering a case where the power of the electromagnetic energy 114 is 150 Watts and where each of the absorber portions 104, 106 and 108 is responsible for absorbing 50 watts, a practicable geometry for each absorber portion 104, 106 and 108 is a length of 1 cm and a width of 2.5 cm with a selected thickness depending on the material characteristics of the absorption material used for each absorber portion 104, 106 and 108. The thickness of the three absorber portions 104, 106 and 108 is different since each subsequent absorber portion 104, 106 and 108 must absorb a greater portion of a relatively smaller power that is incident on it.

Table 3 shows the electromagnetic properties for the three absorption materials examined earlier and the resulting thickness for the absorber portion 106 when made from these absorption materials. The thickness for the RS4200-CHP™ absorption material is greater than that of the other absorption materials because the normalized attenuation is smaller than that of the other absorption materials. The normalized attenuation is a ratio of the attenuation to the dielectric constant for an absorber material. The normalized attenuation value provides a rough estimate of the required thickness for an absorber since a smaller normalized attenuation value indicates that a thicker absorber is required to provide a certain amount of absorption.

TABLE 3
Material Properties For Three Absorption Materials

| Material | MF-124 ™ | RS4200-CHP ™ | TT2-4000 ™ |
|---|---|---|---|
| Attenuation (dB/cm) | 9.6 | 3.2 | 4.8 |
| Dielectric Constant | 25 | 14 | 12 |
| Normalized Attenuation | 0.38 | 0.23 | 0.4 |
| Thickness (mm) | 2.0 | 2.5 | 2.0 |

For uniform volumetric heating, the temperature rise throughout each of the absorber portions 104, 106 and 108 is given by equation 1.

$$Δ T = \frac{Qt}{2 σ A} \qquad ( 1 )$$

where ΔT is the temperature rise, Q is the dissipated power, t is the thickness of the absorber portion in the direction of heat flow, σ is the thermal conductivity of the absorption material, and A is the area of the absorber portion through which the heat flows.

Table 4 summarizes the thermal calculations for this example. The temperature rise is the increase in temperature in the absorber portion 106 due to the absorbed power. The interface temperature is the temperature at the ferrite-adhesive interface. The interface temperature comprises a thermal gradient across the adhesive layer 112 which can be typically 30° C. plus an environmental temperature. An environmental temperature of 95° C. may be encountered in high-power spacecraft applications where the heat from other nearby high power equipment increases the local environmental temperature. The maximum temperature referred to in Table 4 is the addition of the temperature rise through the absorber and the interface temperature. The material temperature limit is the highest temperature that the absorption material may be exposed to without encountering physical damage to the material.

TABLE 4
Thermal Results

| | | RS4200- | |
|---|---|---|---|
| Material | MF-124 ™ | CHP ™ | TT2-4000 ™ |
| Thickness (mm) | 2.0 | 2.5 | 2.0 |
| Thermal Cond. (W/m · K) | 1.0 | 4.4 | 7.2 |
| Temperature rise (° C.) | 200 | 56.8 | 27.8 |
| Interface Temperature (° C.) | 125 | 125 | 125 |
| Maximum Temperature (° C.) | 325 | 182 | 153 |
| Material Temp. Limit (° C.) | 250 | 1000 | 1000 |

As can be seen, the maximum temperature for the MF-124™ absorption material exceeds its allowable temperature which results in physical degradation. This problem can be resolved by using a thinner and longer design for the termination 90 but the physical size and mass of the resulting termination 90 are increased which is a disadvantage for applications where mass and size are important. The advantage of the TT2-4000™ absorption material over the RS4200-CHP™ absorption material is not determined by material limitations but by performance. The RS4200-CHP™ absorption material is less stable than the TT2-4000™ absorption material and has a higher temperature gradient. Accordingly, for the RS4200-CHP™ absorption material to achieve comparable performance to the TT2-4000™ absorption material, a longer and thinner design for the termination 90 is required.

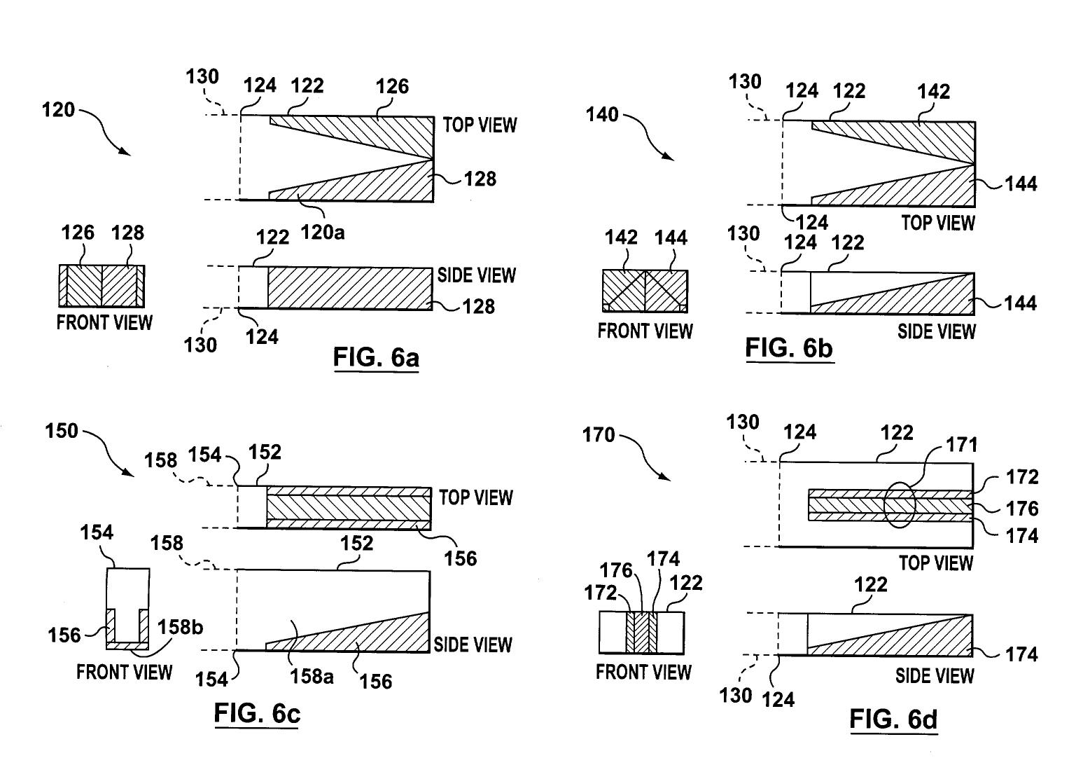

Referring now to FIGS. 6a to 6h, shown therein are further examples of terminations which may utilize the sintered ferrite of the present invention as an absorption material. The terminations shown in FIGS. 6a to 6h are for use with waveguide transmission lines. In each of these Figures, the top, side and front views of the termination are shown (i.e. beginning with the topmost picture and moving clockwise). The Figures are meant to be illustrative and not exhaustive. In each of these Figures, the housing of the termination is shown with a solid line, the absorber is shown with hatched lines and the portion of the waveguide with which the termination is connected is shown by dashed lines. The junction between the termination and the waveguide is also shown in dotted lines. In the top view of each termination, the cover of the termination housing has been removed to show the top of the enclosed absorber. Likewise, in the side view of each termination, the nearest sidewall of the termination housing has been removed to show the side of the enclosed absorber. As is evident from these figures, the housing of each termination must be connected to the waveguide transmission line which may encompass soldering, welding, fasteners or the like as previously discussed. Alternatively, the waveguide transmission line structure may have an extended portion that provides the housing for the termination. The absorber may be inserted into the extended portion of the transmission line structure and fastened thereto using a solder joint or a compliant adhesive. In this case, the portion of the transmission line structure that makes contact with the absorber acts as a heat sink for the termination for the enclosed absorber.

The rectangular waveguide structures shown in FIGS. 6a to 6f may be typically 0.75 inches wide, 2 inches long and 0.375 inches high for frequencies in the neighbourhood of 12 GHz. However, the waveguide structures in FIGS. 6a to 6f may be made using any standard waveguide structure ranging from WR2300 which has a width of 23 inches and is for use at frequencies as low as 256 MHz to WR3 which has a width of 0.03 inches and is for use at frequencies as high as 400 GHz. Non-standard waveguide structures may also be used.

Referring now to FIG. 6a, shown therein is a dual wedge termination 120 having a housing 122, a junction 124, a first absorber element 126 and a second absorber element 128. The termination 120 is connected to a waveguide 130 at the junction 124 which provides an interface through which energy enters the termination 120. The absorber elements 126 and 128 are made of the same absorption material and are tapered to even out the distribution of heat generated within the termination 120 since proportionally smaller amounts of electromagnetic energy are absorbed in the frontal portion 120a of the termination 120 where the high power region occurs. As discussed previously, the electromagnetic energy is at full strength in the high power region since none of the electromagnetic energy has yet been absorbed. The absorber elements are also tapered to reduce the impedance mismatch between the termination 120 and the waveguide 130. The absorber elements 126 and 128 are also attached to the side walls of the housing 122 to facilitate heat transfer thereto. This also places the narrow portion of the absorber element 126 and 128 in the low field region at the side of the waveguide 130, to provide minimal disruption to the electromagnetic energy and hence reduce impedance mismatch.

Referring now to FIG. 6b, shown therein is a dual taper termination 140 having a housing 122, a junction 124, a first absorber element 142 and a second absorber element 144. The absorber elements 142 and 144 are made of the same absorption material. The dual taper termination 140 is similar to the dual wedge termination 120 except that the absorber elements 142 and 144 are tapered on an upward sloping angle as well as being tapered inwards. The horizontal and vertical tapers are illustrated as being equal but this is not necessarily the case.

Referring now to FIG. 6c, shown therein is a channeled wedge termination 150 having a housing 152, a junction 124, and an absorber element 156. The absorber element 156 uses a minimal amount of absorption material. The termination 150 is connected to a waveguide 158 at the junction 124 which provides an interface through which energy enters the termination 150. The absorber element 156 is tapered from a point in the low field region 158a of the waveguide 158. The taper is beneficial for reducing impedance mismatch. The absorber element 156 is configured to have a small thickness and a large area in contact with the wall 158b of the waveguide 158 which is the surface upon which the absorber element 156 is mounted for effective heat transfer thereto.

Referring now to FIG. 6d, shown therein is a dielectric loaded wedge termination 170 having a housing 122, a junction 124 and a composite absorber 171. The composite absorber 171 has a first absorber element 172, a second absorber element 174 and a dielectric 176 disposed therebetween. The first and second absorber elements 172 and 174 are made of the same absorption material. The dielectric 176 is a low dielectric constant material such as boron nitride. The material used for the dielectric 176 is selected to adjust the proportion of the electromagnetic energy within the absorber elements 172 and 174. The dielectric 176 also provides structural support for the absorber elements 172 and 174 which may be quite thin. Furthermore, the dielectric 176 provides a thermally conductive path to dissipate the heat generated within the absorber elements 172 and 174.

Referring now to FIG. 6e, shown therein is a slab termination 180 having a housing 122, a junction 124 and an absorber element 182 which is configured in a triangular formation. The absorber element 182 is thin with a large surface area to more effectively dissipate the heat generated therein. The absorber element 182 is shown as being tapered although this is not required. The absorber element 182 may also be configured as a partial height dual wedge. Furthermore, the absorber element 182 is shown on the bottom wall for illustration purposes only and may alternatively or additionally be placed on the top wall of the housing 122.

Referring now to FIG. 6f, shown therein is a stepped termination 190 having a housing 122, a junction 124 and an absorber element 192 with a first step 194 and a second step 196. The termination 190 is often used to provide a compact design, since instead of utilizing a taper to reduce the amount of reflected energy, two steps 194 and 196 are arranged such that the reflected energy from the first step 194 cancels the reflected energy from the second step 196. However, the termination 190 has a narrower frequency response and is more sensitive to material variation than a tapered design. Although two steps are shown, multiple steps may also be used. Furthermore, although a single absorber element is shown, the absorber may be fabricated from two or more absorber elements which need not be made from the same material.

Referring now to FIG. 6g, shown therein is a cylindrical termination 200 for use with a cylindrical waveguide 202. The cylindrical termination 200 comprises a housing 204, a junction 206 and an annular absorber 208 that has been circumscribed by an inclined plane. The termination 200 is connected to the circular waveguide 202 at the junction 206 that provides an interface through which energy enters the termination 200. Other implementations may also be possible such as having two absorber elements which envelope the top and bottom portions of the cylindrical waveguide 202. Alternatively, the absorber 208 may form a complete annulus around the circumference of the cylindrical waveguide 202. In another alternative, the thickness of the annulus may be tapered or stepped along the length of the annulus.

Referring now to FIG. 6h, shown therein is a ridged termination 220 for use in a ridged waveguide 222. The ridged termination 220 has a housing 224, a junction 226 and first and second absorber elements 228 and 230. The termination 220 is connected to the ridged waveguide 222 at the junction 226 which provides an interface through which energy enters the termination 220. The absorber elements 228 and 230 are tapered slabs that are made of the same absorption material and are placed adjacent to the high field region of the ridged waveguide 222. Alternatively, other implementations of the ridged termination 222 may be possible such as having the absorber elements 228 and 230 be full height, with or without a tapered width.

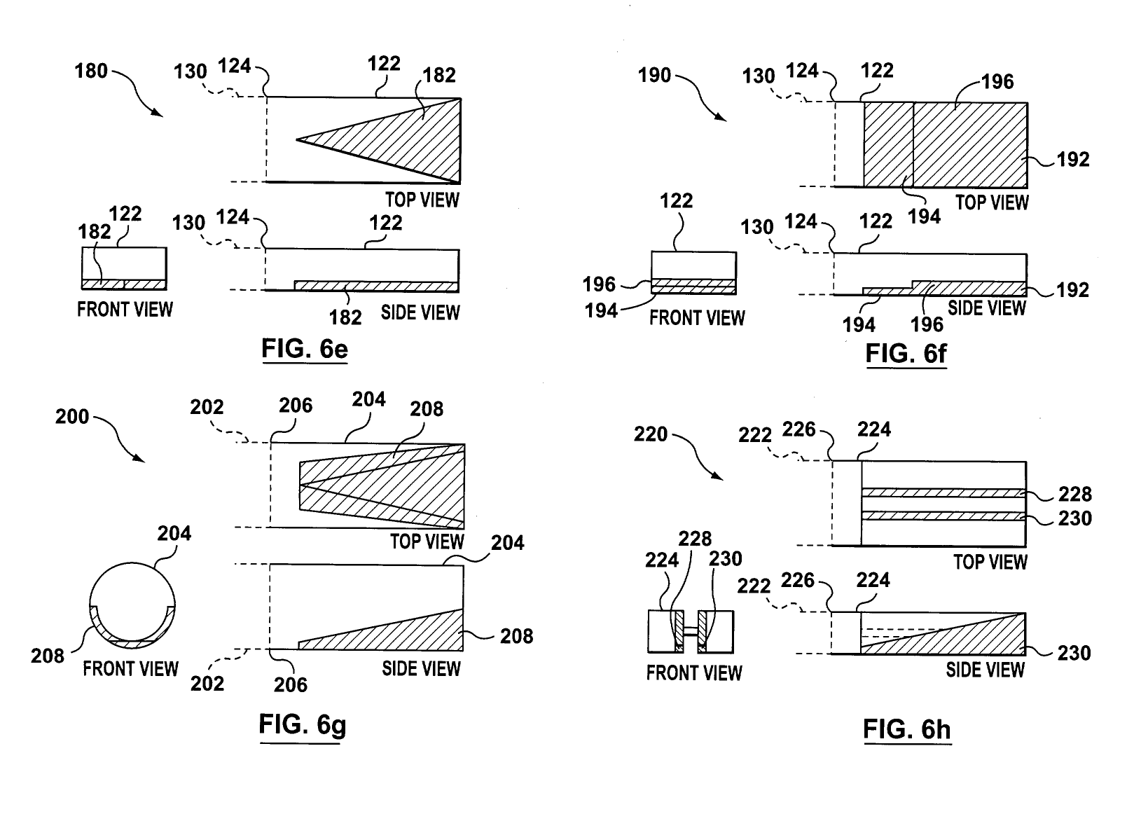

Referring now to FIGS. 7a to 7c, shown therein are examples of coaxial terminations 240, 260 and 270 for use in a coaxial transmission line 242 which may use the sintered ferrite of the present invention as an absorption material. The coaxial transmission line 242 is represented by dash-dotted lines and has an outer conductor 244 and an inner conductor 246. The space around the frontal portions 252 and 262 of the terminations 240 and 260, as well as the space within the frontal portion 272 of the termination 270 is occupied by a dielectric (not shown) which may be teflon™, air, vacuum or some other dielectric. The dielectric is often the same material that is used to support the inner conductor 246 in the attached coaxial transmission line 242. Using the same dielectric facilitates an impedance match between the terminations 240, 260 and 270 and the coaxial transmission line 242 but different dielectrics may be used to achieve a special purpose. For example, boron nitride may be used to facilitate heat transfer and the geometry of each termination 240, 260 and 270 may be adjusted to retain an adequate impedance match.

The coaxial termination 240 (see FIG. 7a) has a housing 248, and a conductor 250. The termination 240 is connected to the coaxial transmission line 242 at a junction 256 which provides an interface through which energy enters the termination 240. The conductor 250 physically and electrically contacts the inner conductor 246. The coaxial termination 240 additionally includes first and second absorber elements 252 and 254 both have an inner hole for receiving the inner conductor 250. The absorber elements 252 and 254 have a step transition therebetween for minimizing the mismatch between the impedance of the coaxial termination 240 and the impedance of the coaxial transmission line 242. The sizes of the absorber elements 252 and 254 also allow for adjusting the amount of absorption provided by the termination 240 and the heat that is generated therein.

The coaxial termination 260 (see FIG. 7b) has a housing 248 and a conductor 250. The termination 260 is connected to the coaxial transmission line 242 at a junction 256 which provides an interface through which energy enters the termination 260. The conductor 250 physically and electrically contacts the inner conductor 246. The coaxial termination 260 additionally includes a conically tapered absorber element 262 and a base absorber element 264 with both of these elements having a hole within which the conductor 250 is placed. The absorber elements 262 and 264 may be made from the same absorption material and even machined as one piece. The conically tapered absorber element 262 allows for the adjustment of the absorption profile of the coaxial termination 260 as well as for reducing the impedance mismatch between the coaxial termination 260 and the coaxial transmission line 242.

The coaxial termination 270 (see FIG. 7c) has a housing 248 and a conductor 250. The termination 270 is connected to the coaxial transmission line 242 at a junction 256 which provides an interface through which energy enters the termination 270. The conductor 250 physically and electrically contacts the inner conductor 246. The coaxial termination 270 additionally includes an inverted conically tapered absorber element 272 and a base absorber element 274. Element 274 has a hole within which the conductor 250 is placed. The dashed lines 276 show the taper of the inverted conically tapered absorber element 272. The inverted conically tapered absorber element 272 has a thin frontal portion 272a which tapers inwardly to provide a thicker absorber towards the rear 272b of the absorber element 272. This thinner frontal portion 272a is beneficial for absorbing a smaller amount of electromagnetic energy in the high power region of the coaxial transmission line 242 as well as minimizing the impedance mismatch between the coaxial termination 270 and the coaxial transmission line 242. The absorber element 172 also has a large area in contact with the housing 248 for effective heat transfer thereto.

The ferrite absorption material of the present invention may also find utility in other electronic devices which absorb at least a portion of electromagnetic energy that is provided by a transmission line structure. For example, the ferrite absorption material disclosed herein may be used in an attenuator. The attenuator may have a structure like that of the test device 10 discussed previously. The connector 14 serves as the input interface of the attenuator and receives the electromagnetic energy 17 from the transmission line structure 16. The connector 14 is attached to the conductor 20 which guides the electromagnetic energy 17 to the absorber 18. The absorber 18 attenuates or reduces the amount of the electromagnetic energy to provide reduced or remaining electromagnetic energy 17′ to a downstream device. The reduced or remaining electromagnetic energy 17′ is transferred to the output connector 22 which serves as a second interface. The connector 22 provides the reduced electromagnetic energy 17′ to the downstream transmission line structure 16′ for transmission therealong. The size and shape of the absorber 18 are chosen such that the attenuator provides a desired level of attenuation. The absorber 18 may have the shapes previously discussed. Furthermore, the absorber 18 may be a composite absorber having the features previously discussed.

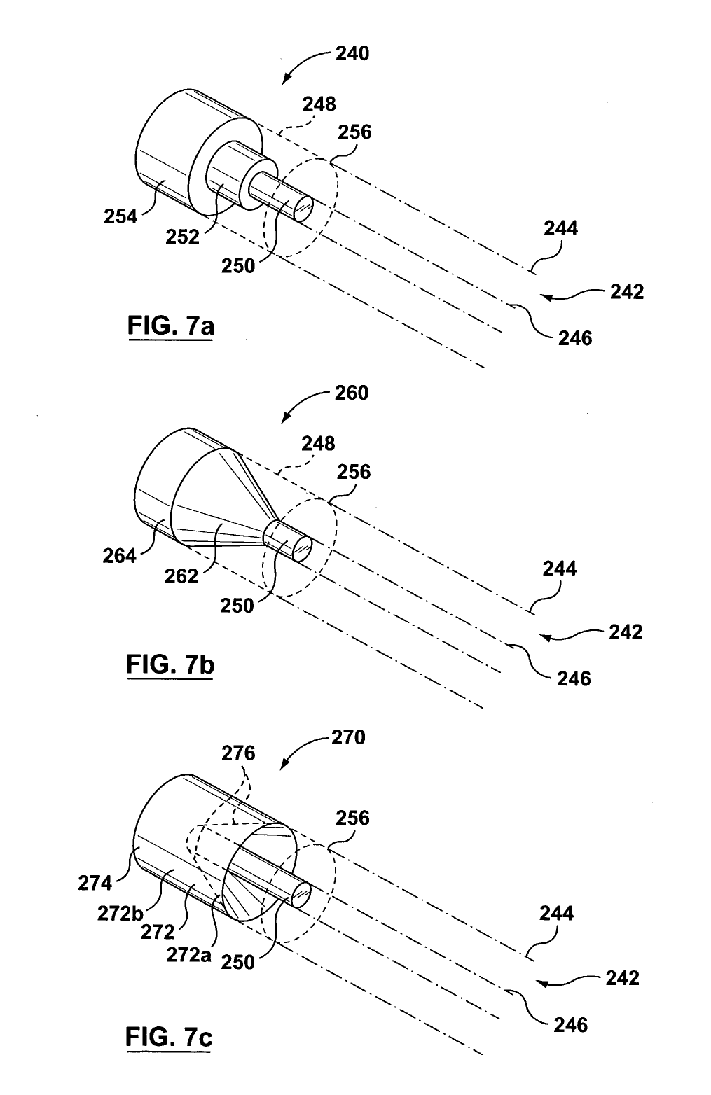

Another example of an attenuator 300 that may utilize the ferrite absorption material of the present invention is shown in FIG. 8. The attenuator 300 is for use with waveguide transmission line structures. The attenuator 300 has a waveguide which serves as a housing 302 for providing an internal transmission line for the attenuator 300. Both ends 304 and 306 of the waveguide housing 302 serve as interfaces for receiving and transmitting electromagnetic energy. The attenuator 300 additionally includes an absorber 308 disposed within the housing 302 for attenuating or reducing electromagnetic energy that is provided to the attenuator 300. The absorber 308 may be soldered to the housing 302 if the absorber 308 and the housing 302 have a similar coefficient of thermal expansion. Alternatively, the absorber 308 may be bonded to the housing 302 via a thermally compliant adhesive such as RTV™ for example.

The end 304 of the housing 302 is attached to a waveguide 310 that provides incoming electromagnetic energy 312. The end 304 of the housing 302 may have a flange 314 that is attached to a flange 316 on the waveguide 310 via fasteners such as bolts. The housing 302 guides the incoming electromagnetic energy 312 to the absorber 308 which attenuates the incoming electromagnetic energy 312 to produce reduced electromagnetic energy 318 that is transferred to the end 306. The end 306 of the housing 302 is attached to a downstream transmission line structure 320 for transmitting the reduced electromagnetic energy 318 therealong. The end 306 may have a flange 322 that is attached to a flange 324 on the waveguide 320 via fasteners such as bolts. The size and shape of the absorber 308 may be chosen such that the attenuator 300 provides a desired level of attenuation. The absorber 308 may have the shapes previously discussed. Furthermore, the absorber 308 may be a composite absorber having the features previously discussed. Alternatively, at least one of the waveguides 310 and 320 may provide an extension that provides the housing 302 for the attenuator 300.

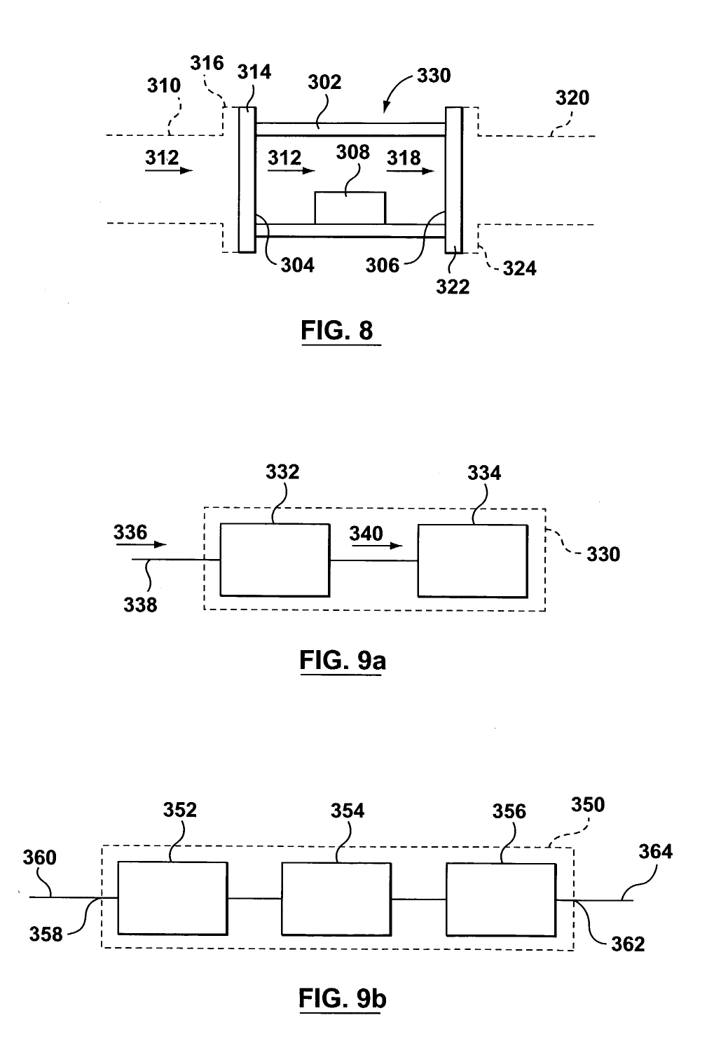

The attenuators disclosed herein may be combined with prior art terminations to provide a composite device 330 as shown schematically in FIG. 9a. The composite device 330 is adapted to absorb substantially all of the electromagnetic energy that is provided thereto. The composite device 330 comprises an attenuator 332 followed by a downstream termination 334. The downstream termination 334 may be formed from a second absorber disposed within a second housing. The composite device 330 receives incoming electromagnetic energy 336 from a transmission line 338 that is connected to the attenuator 332. The attenuator 332 attenuates the incoming electromagnetic energy 336, as described previously, to provide reduced or remaining electromagnetic energy 340 to the termination 334, which absorbs substantially all of the reduced or remaining electromagnetic energy 340. The usage of the attenuator 332, to provide the reduced electromagnetic energy 340, allows for a reduction in the amount of absorption that the termination 334 must provide in comparison to the amount of absorption required if the entire incident electromagnetic energy 336 were provided to the termination 334.

The attenuator 332 and the termination 334 may each have a separate housing that are attached to each other via appropriate junctions or connectors and an appropriate transmission line structure. Alternatively, the attenuator 332 and the termination 334 may be within the same housing.

The attenuators disclosed herein may also be combined into a composite device 350 as shown schematically in FIG. 9b to provide a certain level of attenuation. The composite device 350 may contain any number of attenuators. In this example three attenuators 352, 354 and 354 are shown. The composite device 350 has a first junction 358 that provides an interface for connection to an upstream transmission line structure 360 and a second junction 362 that provides an interface for connection to a downstream transmission line structure 364. The use of several attenuators allows for flexibility in the design of each attenuator 352, 354 and 356.

It should be borne in mind that there may be a wide variety of sintered ferrite materials that are suitable for high power applications since the chemical composition of a ferrite can be changed to tailor its electromagnetic properties. For instance, the general formula for the ferrite described above is MFe₂O₄ or equivalently MOFe₂O₃ where M is a divalent cation and MO is a divalent metal oxide. Substitutions can be made for the divalent cation. For instance, magnesium, manganese, nickel, cobalt and zinc are common substitutions. Monovalent lithium in equal amounts with trivalent iron is also a common substitution. Substitutions may also be made for a portion of the trivalent iron. Common substitutions include aluminum and gadolinium. In addition, some trace elements may be added to the ferrite to facilitate production of the absorption material or to alter properties of the ferrite such as resistivity or magnetostriction as is commonly known by those skilled in the art. The text, “Handbook of Microwave Ferrite Materials”, Academic Press, © 1965, edited by Wilhelm von Avlock provides insight into the variety of material formulations that are possible.

It should be understood that various modifications can be made to the preferred embodiments described and illustrated herein, without departing from the present invention, the scope of which is defined in the appended claims. For instance, tuning elements such as tuning screws, tuning pills or dielectric may be added to fine tune device performance. Features may also be incorporated to align or fix the absorber within the housing. It should further be understood that the ferrite absorber described herein may be used in a termination that is for use with any transmission line structure such as, but not limited to, a waveguide, a coaxial, a stripline or a microstrip transmission line structure.

Furthermore, the geometry and/or composition of the transmission line structure that is attached to the termination may be altered to facilitate an improved impedance match between the termination and the transmission line structure. For instance, if the transmission line structure is a waveguide, then the walls of the waveguide may be tapered. Alternatively, if the transmission line structure is a coaxial transmission line then the diameter of the outer conductor and/or the inner conductor may be varied. In addition, an appropriate dielectric may be used in the transmission line structure such as a dielectric having a low dielectric constant like teflon™ or a dielectric having an excellent thermal conductivity like boron nitride.

1. A device for absorbing at least a portion of electromagnetic energy provided by a transmission line and for transferring resulting heat generated by absorption of said at least portion of electromagnetic energy to a heat sink, said device comprising:
a) a housing in communication with said transmission line for receiving said electromagnetic energy and for providing at least a portion of an internal transmission line for confining and guiding said electromagnetic energy within said device, said housing also being in communication with said heat sink for transferring said resulting heat thereto; and,
b) an absorber in communication with said housing for receiving said electromagnetic energy, absorbing said at least portion of electromagnetic energy and providing said resulting heat to said housing, wherein said absorber comprises ferrite.

2. The device of claim 1, wherein said internal transmission line further comprises a conductor disposed within said housing.

3. The device of claim 1, wherein said device is a termination and said absorber is adapted to absorb substantially all of said electromagnetic energy provided by said transmission line.

4. The device of claim 1, wherein said device is an attenuator, said attenuator further being in communication with a downstream transmission line for providing remaining electromagnetic energy thereto.

5. The device of claim 1, wherein said device comprises an attenuator and a downstream termination, said attenuator in communication with said termination, wherein at least one of the attenuator and the termination have a housing and an absorber in accordance with the housing and absorber of said device.

6. The device of claim 5, wherein the attenuator and the termination are in the same housing.

7. The device of claim 1, wherein said ferrite has a thermal conductivity of at least approximately 3.2 W/m·K.

8. The device of claim 1, wherein said ferrite has a Curie temperature of at least approximately 300° C.

9. The device of claim 1, wherein said ferrite has a dielectric constant of at least approximately 12.

10. The device of claim 1, wherein said ferrite is sintered.

11. The device of claim 1, wherein said ferrite is a Ni—Zn ferrite.

12. The device of claim 11, wherein said Ni—Zn ferrite has approximately a 20% Ni composition and an 80% Zn composition.

13. The device of claim 1, wherein said ferrite is a Lithium-based ferrite.

14. The device of claim 13, wherein said Lithium-based ferrite has a Curie temperature of approximately at least 300° C.

15. The device of claim 1, wherein said absorber is a composite absorber comprising an absorber and a dielectric.

16. The device of claim 15, wherein said dielectric has a lower dielectric constant than said absorber.

17. The device of claim 1, wherein said absorber has a thickness that is varied to vary the absorption profile of said absorber.

18. The device of claim 17, wherein the thickness of said absorber varies along the direction of propagation of said electromagnetic energy.

19. The device of claim 17, wherein the thickness of said absorber varies in a direction transverse to the direction of propagation of said electromagnetic energy.

20. A device for absorbing at least a portion of electromagnetic energy propagated within a transmission line, and for transferring resulting heat generated by absorption of said at least portion of electromagnetic energy to a heat sink, said transmission line having an extension that provides a housing for said device, said housing being in communication with said heat sink for transferring said resulting heat thereto and said housing providing an internal transmission line for confining and guiding said electromagnetic energy within said device, wherein said device additionally includes:
a) an absorber disposed within said housing, said absorber being in communication with said internal transmission line and said housing for receiving said electromagnetic energy, absorbing said at least portion of electromagnetic energy and transferring said resulting heat to said housing, wherein said absorber comprises ferrite.

21. The device of claim 20, wherein said device is a termination and said absorber is adapted to absorb substantially all of said electromagnetic energy propagated within said transmission line.

22. The device of claim 20, wherein said device is an attenuator, said attenuator further being in communication with a downstream transmission line for providing remaining electromagnetic energy thereto.

23. The device of claim 20, wherein said device comprises an attenuator and a downstream termination, the attenuator being in communication with the termination, wherein at least one of the aftenuator and the termination have a housing and an absorber in accordance with the housing and absorber of said device.

24. The device of claim 23, wherein said attenuator and said termination are enclosed within the same housing.

25. The device of claim 20, wherein said ferrite has a thermal conductivity of at least approximately 3.2 W/m·K.

26. The device of claim 20, wherein said ferrite has a Curie temperature of at least approximately 300° C.

27. The device of claim 20, wherein said ferrite has a dielectric constant of at least approximately 12.

28. The device of claim 20, wherein said ferrite is sintered.

29. The device of claim 20, wherein said ferrite is a Ni—Zn ferrite.

30. The device of claim 29, wherein said Ni—Zn ferrite has approximately a 20% Ni composition and an 80% Zn composition.

31. The device of claim 20, wherein said ferrite is a Lithium-based ferrite.

32. The device of claim 31, wherein said Lithium-based ferrite has a Curie temperature of at least approximately 300° C.

33. The device of claim 20, wherein said absorber is a composite absorber comprising an absorber and a dielectric.

34. The device of claim 33, wherein said dielectric has a lower dielectric constant than said absorber.

35. The device of claim 20, wherein said absorber has a thickness that is varied to vary the absorption profile of said absorber.

36. The device of claim 34, wherein the thickness of said absorber varies along the direction of propagation of said electromagnetic energy.

37. The device of claim 34, wherein the thickness of said absorber varies in a direction transverse to the direction of propagation of said electromagnetic energy.
